(19) United States
(12) Patent Application Publication
(10) Pub. No.: US 2010/0318938 A1
(43) Pub. Date: Dec. 16, 2010

(54) METHOD AND APPARATUS FOR DISPLAYING SEARCH DATA

(75) Inventors: Do Hyung KIM, Daejeon (KR); Bon Ki KOO, Daejeon (KR)

Correspondence Address: LOWE HAUPTMAN HAM & BERNER, LLP, 1700 DIAGONAL ROAD, SUITE 300, ALEXANDRIA, VA, 22314, US

(73) Assignee: Electronics and Telecommunications Research Institute, Daejeon (KR)

(21) Appl. No.: 12/788,813

(22) Filed: May 27, 2010

(30) Foreign Application Priority Data
Jun. 15, 2009 (KR) 10-2009-0052877

(51) Int. Cl. G06F 3/048

(52) U.S. Cl. 715/823

(57) ABSTRACT

Provided are a method and an apparatus for displaying search data. The method includes generating an identifier representing selected data if one of data displayed on a screen is selected, displaying the identifier on the screen and maintaining the identifier on the screen even when another data is being displayed, and displaying data corresponding to selected identifier if the identifier maintained on the screen is selected.

### CROSS-REFERENCE TO RELATED APPLICATIONS

This application claims priority under 35 U.S.C. §119 to Korean Patent Application No. 10-2009-0052877, filed on Jun. 15, 2009, in the Korean Intellectual Property Office, the disclosure of which is incorporated herein by reference in its entirety.

### TECHNICAL FIELD

The following disclosure relates to a method and an apparatus for displaying search data, and in particular, to a method and an apparatus for displaying search data, which generate an identifier corresponding to interested data among the search data and display the identifier on a screen, and display the interested data on the screen if the identifier displayed on the screen is selected.

### BACKGROUND

Sliders or scrollbars are widely used to search data such as music, images, videos, web pages, and directories. This is a generalized data search method, which enables an inter-object search and an object search. For example, the inter-object search means searching a desired file in music files, and the object search means searching a desired section in a music file. Recently, domain of search target is steadily increasing. As the domain of search target increases, data search using a slider or a scrollbar has a limitation in that, even though a user wants to return to a specific position that the user is aware of, e.g., a desired data position, it is not easy to find the corresponding position.

### SUMMARY

In one general aspect, a method for displaying search data includes: generating an identifier representing selected data if one of data displayed on a screen is selected; displaying the identifier on the screen and maintaining the identifier on the screen even when another data is being displayed; and displaying data corresponding to selected identifier if the identifier maintained on the screen is selected.

In another general aspect, a method for displaying search data on a display window according to movement of a thumb of a slider or a scrollbar displayed on the display window of a screen includes: generating an identifier representing selected data if one of the search data is selected; displaying the identifier on the display window; maintaining the identifier on the display window for a certain time even when another search data is being displayed according to the movement of the thumb; and displaying data corresponding to selected identifier on the display window if the maintained identifier is selected.

In still another general aspect, an apparatus for displaying search data includes: a display unit displaying data; and a control unit generating an identifier representing selected data to display the identifier on a screen of the display unit if one of data displayed on the display unit is selected, maintaining the identifier on the screen even when another data is being displayed, and displaying the data corresponding to the identifier on the screen if the identifier maintained on the screen is selected.

Other features and aspects will be apparent from the following detailed description, the drawings, and the claims.

### BRIEF DESCRIPTION OF THE DRAWINGS

FIGS. 1 to 4 are diagrams illustrating a method for displaying search data according to an exemplary embodiment.

FIGS. 5 to 8 are diagrams illustrating a method for displaying search data according to another exemplary embodiment.

FIG. 9 is a block diagram illustrating an apparatus for displaying search data according to an exemplary embodiment.

### DETAILED DESCRIPTION OF EMBODIMENTS

Advantages and features of the present invention, and implementation methods thereof will be clarified through following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Further, the present invention is only defined by scopes of claims. In the following description, the technical terms are used only for explaining a specific exemplary embodiment while not limiting the present invention. The terms of a singular form may include plural forms unless referred to the contrary. The meaning of “include,” “comprise,” “including,” or “comprising,” specifies a property, a region, a fixed number, a step, a process, an element and/or a component but does not exclude other properties, regions, fixed numbers, steps, processes, elements and/or components.

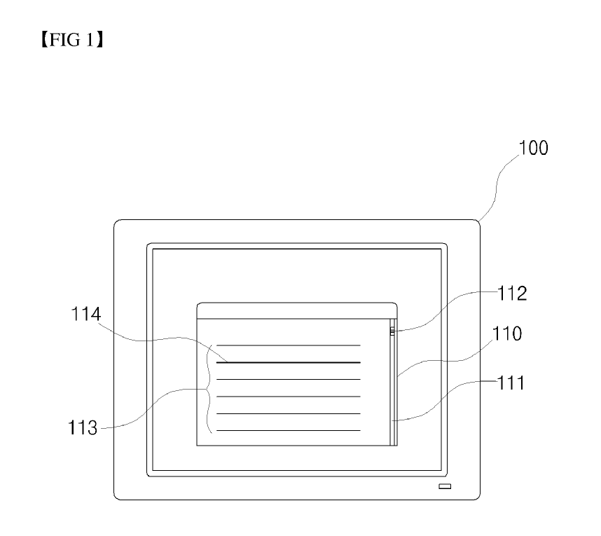

Hereinafter, a method for display search data according to an exemplary embodiment will be described in detail with reference to FIGS. 1 to 4. FIGS. 1 to 4 are diagrams illustrating a method for displaying search data according to an exemplary embodiment.

As shown in FIG. 1, if an executable file of a specific display window 110 is selected from a screen 100 by a user, the selected executable file may be executed to display the specific display window 110 on the screen 100. For example, if an executable file of a web browser 110 of a display device, e.g., a monitor screen (where images or pictures are displayed) 100 is executed, the web browser 110 is displayed on the screen 100. If a thumb 112 of a slider or a scrollbar 111 is moved by a user, then data may be searched, and search data may be displayed on the web browser 110.

If one of data 113 that is searched and displayed on the web browser 110 is selected by a user as necessary or interested data, an identifier 115 representing the selected data 114 may be generated. Examples of methods for selecting the interested data may include (a) menu, (b) shortcut key, (c) eye-gaze, (d) gesture, and (e) user's response such as area selection, copy, and input. For example, the identifier may be generated by representing features of the selected data as multimedia data, e.g., thumbnails, and linking the multimedia data to the position of the selected data, e.g., URL. Alternatively, if the thumb 112 stays for a certain time at a position of one of data 113 that is searched and displayed on the web browser 110, then data corresponding to the position where the thumb 112 stays for a certain time may be selected on its own even though the data is not selected by a user, and an identifier representing the selected data may be generated. Otherwise, if one of data 113 that is searched and displayed is modified or evaluated as interested data by a user, then the modified and evaluated data may be selected on its own even though the data is not directly selected by a user, and an identifier representing the selected data may be generated.

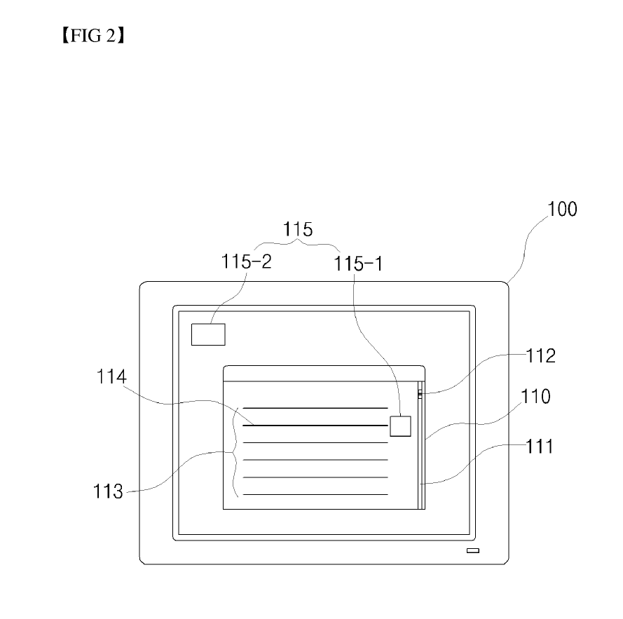

The generated identifier may be displayed on the screen 100. As shown in FIG. 2, the generated identifier 115-1 may be displayed on only the web browser 110, or the generated identifier 115-2 may be displayed on anywhere of the screen 100 including the web browser 110.

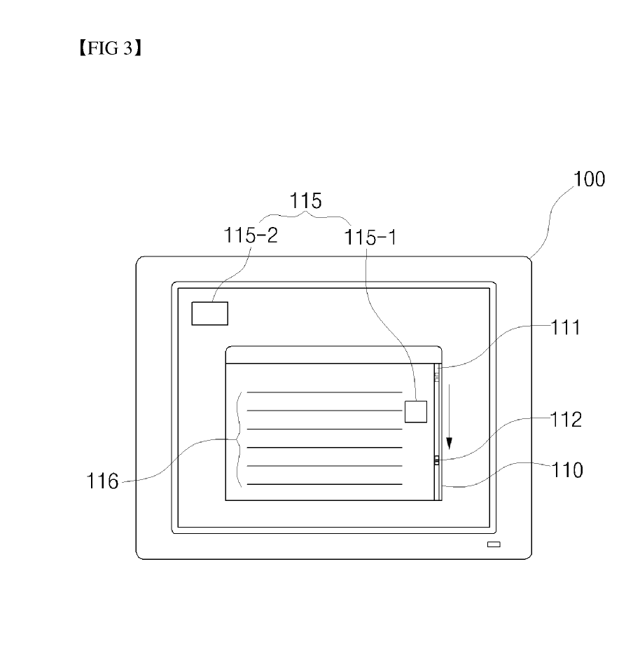

After the identifier 115 is generated and displayed, the thumb 112 of the scrollbar 111 or the slider displayed on the web browser 110 may be moved by a user, thereby searching another data. As shown in FIG. 3, another search data 116 may be displayed on the web browser 110. Thus, while another search data is being displayed on the web browser 110, the generated identifier 115 may be still displayed on the screen 100. The display of the identifier 115-1 may be maintained on only the web browser 110, and the display of the identifier 115-2 may be maintained on anywhere of the screen 100 including the web browser 110.

The display of the identifier 115 may be maintained on the screen 100 for a certain time. The display of the identifier 115 may be maintained for a certain time at a first position of the screen 100 where the identifier 115 is generated for the first time, and may be maintained for a certain time at moving positions of the screen 100.

The display of the identifier 115 on the screen 100 may be expired. When the display of the identifier 115 is maintained at the first position where the identifier 115 is displayed for the first time, the display of the identifier 115 on the screen 100 may be expired after a certain time. When the display of the identifier 115 is moved around the screen 100, the display of the identifier 115 on the screen may be expired if the movement time of the identifier 115 reaches a predetermined time or the identifier 115 is moved to a predetermined position. If the display of the identifier 115 is expired according to the movement of the identifier 115, then an initial position or time when the identifier 155 may be displayed for the first time is calculated, and the display of the identifier 115 on the screen 100 may be expired on the basis of the initial position and the predetermined position or the initial time and the predetermined time.

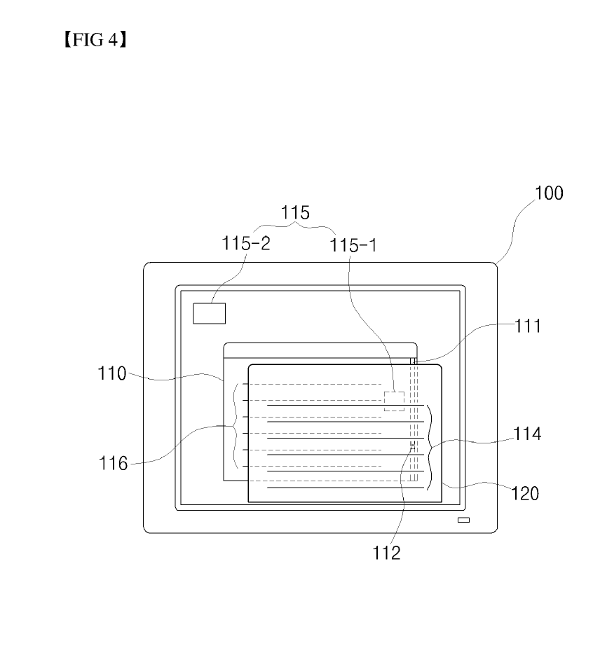

If the identifier 115 displayed on the screen 100 is selected, data corresponding to the selected identifier 115 may be displayed on the screen 100. For example, as shown in FIG. 4, if the identifier 115 maintained on the screen 100 is selected while another search data 116 is being displayed on the web browser 110, data 114 corresponding to the selected identifier 115 may be displayed on another web browser 120 based on URL of the data 114 because the selected identifier 115 is linked to the URL of the data 114.

Accordingly, when necessary or interested data is found during searching of extensive data on the screen 100, the necessary or interested data is selected to generate an identifier representing the selected data. The generated identifier is displayed on the screen 100 for a certain time. When a user intends to display the necessary or interested data that has been previously found on the screen 100 during continuous searching of extensive data, the user can select the generated identifier on the screen 100. Thus, the necessary or interested data can be easily and conveniently searched without continuously scrolling up and down the screen 100 using a thumb of a slider or a scrollbar until desired data is displayed on the screen 100.

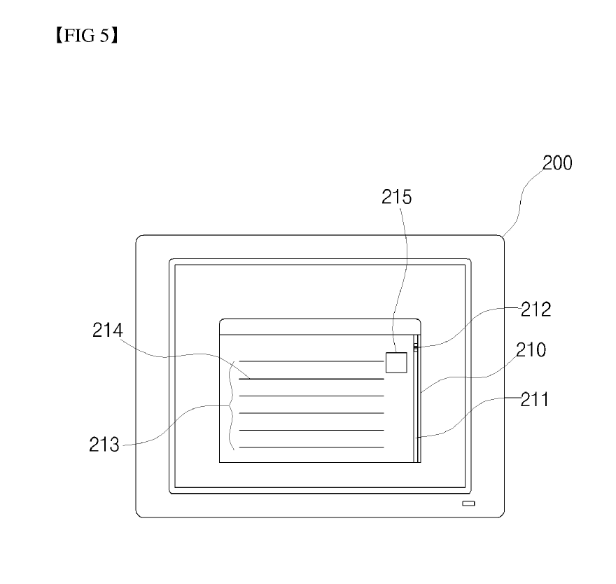

As described above, a method for displaying search data according to an exemplary embodiment has been described. Hereinafter, a method for displaying search data according to another exemplary embodiment will be described in detail with reference to FIGS. 5 to 8. FIGS. 5 to 8 are diagrams illustrating a method for displaying search data according to another exemplary embodiment.

As shown FIG. 5, data may be searched according to movement of a thumb 212 of a slider or a scrollbar 211 in a display window of a screen 200, e.g., an MS Excel window 210, which may display the searched data. For example, if an Excel executable file is executed on the screen 200, an Excel window 210 is displayed on the screen 200. When a file including necessary or interested information is loaded onto the Excel window 210, data included in the file may be displayed on the Excel window 210.

While the data displayed on the Excel window 210 is searched according to the movement of the thumb 212, necessary or interested data may be selected. If data is selected, then an identifier 215 representing the selected data may be generated, and the generated identifier 215 may be displayed on the Excel window 210.

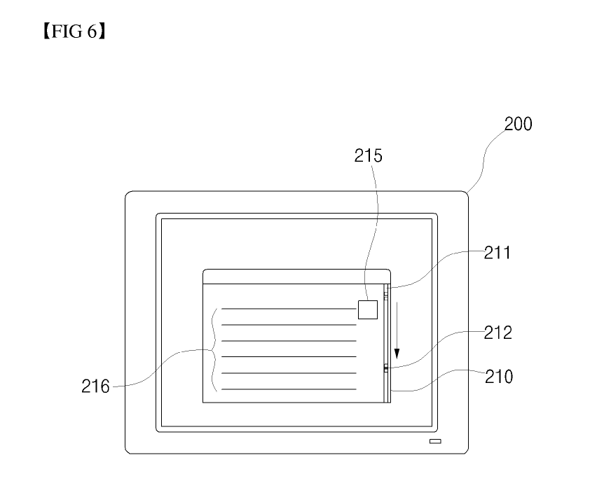

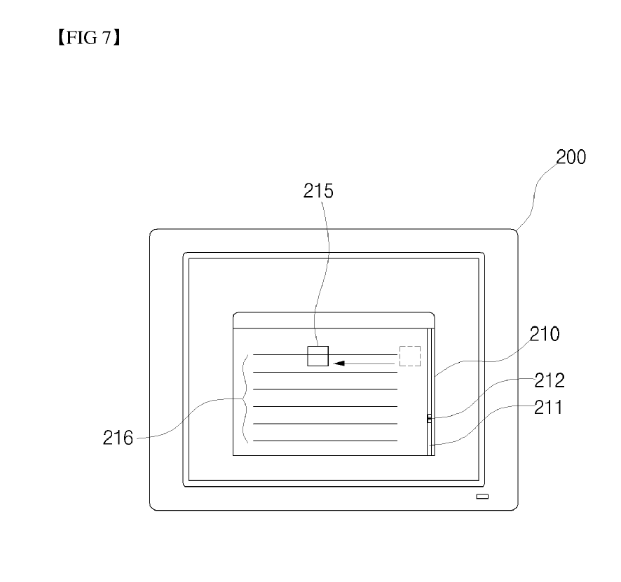

As shown in FIG. 6, the display of the identifier 215 may be maintained on the Excel window 210 for a certain time while another search data 216 is being displayed on the Excel window 210 according to the movement of the thumb 212. As shown in FIG. 7, while the display of the identifier 215 is being maintained on the Excel window 210, the identifier 215 may be moved from the Excel window 210. The identifier 215 may be moved from a displayed position to a predetermined position, may be moved in a straight line, or may be moved in a diagonal direction or in a circle.

After a certain time, the identifier 215 may be expired and removed from the Excel window. For example, if the movement time of the identifier 215 exceeds a certain time, or the identifier 215 is moved to a predetermined position for a predetermined time, then the identifier 215 may be expired and removed from the Excel window 210.

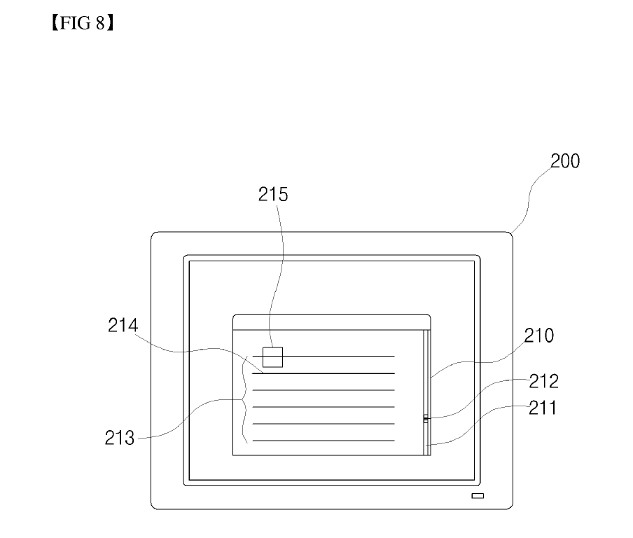

If the identifier 215 maintained on the Excel window 210 is selected, data corresponding to the selected identifier 215 may be displayed on the Excel window 210. For example, if the identifier 215 is selected while another search data 21 is being displayed on the Excel window 210, as shown in FIG. 8, the data 214 corresponding to the selected identifier 215 may be displayed on the same Excel window 210, not on a different Excel window.

Accordingly, when necessary or interested data is found during searching of extensive data on the Excel window 210, the necessary or interested data is selected to generate an identifier representing the selected data. The generated identifier is displayed on the Excel window 210 for a certain time. When a user intends to verify the necessary or interested data that has previously been found on the Excel window 210 during continuous searching of extensive data, the user can select the generated identifier on the Excel window 210. Thus, the necessary or interested data can be easily and conveniently searched without continuously scrolling up and down the Excel window 210 using a thumb of a slider or a scrollbar until desired data is displayed on the Excel window 210.

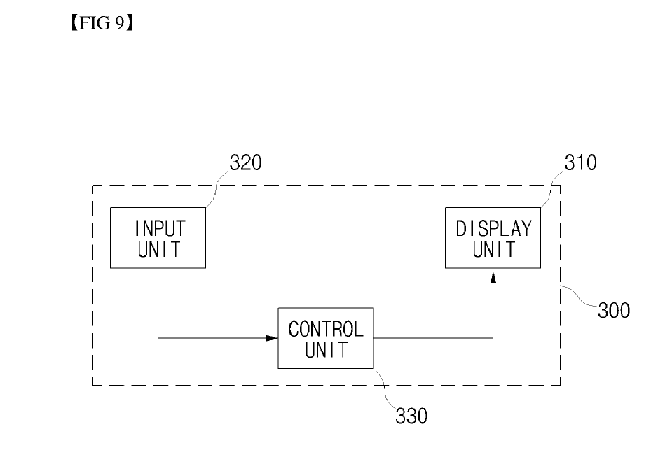

As described above, a method for displaying search data according to another exemplary embodiment has been described. Hereinafter, an apparatus for displaying search data according to an exemplary embodiment will be described in detail with reference to FIG. 9. FIG. 9 is a block diagram illustrating an apparatus for displaying search data according to an exemplary embodiment.

As shown in FIG. 9, an apparatus for displaying search data includes a display unit 310, an input unit 320, and a control unit 330.

The display unit 310 may display data.

The input unit 320 may receive commands from a user.

The control unit 330 may generate an identifier representing selected data and control the display unit 310 to display the identifier on a screen of the display unit 310 if a user selects one of data displayed on the display unit 310 through the input unit 320. The control unit 330 may control the display unit 310 to maintain the identifier on the screen even when another data is being displayed by an input of a user through the input unit 320. If the identifier maintained on the screen is selected by a user through the input unit 320, the control unit 330 may control the display unit 310 to display data corresponding to the selected identifier on the screen.

For example, when data is displayed on a specific display window of the screen, the control unit 330 may control the display unit 310 to display an identifier on the specific display window. Also, the control unit 330 may control the display unit 310 to maintain the identifier on the specific display window even when another data is displayed.

The control unit 330 may control the display unit 310 to maintain the identifier on the screen for a certain time, and may control the display unit 310 to remove the identifier from the screen after a certain time.

When controlling the display unit 310 to move the identifier around the screen, the control unit 330 may control the display unit 310 to remove the identifier from the screen if a predetermined time is up, or if the identifier is moved to a predetermined position.

The control unit 330 may calculate an initial position or time when the identifier is displayed for the first time, and may control the display unit 310 to remove the identifier on the basis of the initial position and the predetermined position or the initial time and the predetermined time.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for displaying search data, comprising:
generating an identifier representing selected data if one of data displayed on a screen is selected;
displaying the identifier on the screen and maintaining the identifier on the screen even when another data is being displayed; and
displaying data corresponding to selected identifier if the identifier maintained on the screen is selected.

2. The method of claim 1, wherein the generating of an identifier comprises:
indicating features of the selected data using multimedia data; and
linking a position of the selected data to the multimedia data.

3. The method of claim 1, wherein, when the data is displayed on a specific display window of the screen, the maintaining of the identifier comprises displaying the identifier on the specific display window and maintaining the identifier on the specific window even when the other data is being displayed.

4. The method of claim 1, wherein the maintaining of the identifier comprises maintaining the identifier on the screen for a certain time.

5. The method of claim 4, wherein the maintaining of the identifier further comprises removing the identifier from the screen after the certain time.

6. The method of claim 1, wherein the maintaining of the identifier comprises moving the identifier around the screen.

7. The method of claim 6, wherein the maintaining of the identifier further comprises removing the identifier from the screen if a predetermined time is up, or if the identifier is moved to a predetermined position.

8. The method of claim 7, wherein the moving of the identifier comprises calculating an initial position or time when the identifier is displayed for the first time, and
the removing of the identifier comprises removing the identifier on the basis of the initial position and the predetermined position or the initial time and the predetermined time.

9. A method for displaying search data on a display window according to movement of a thumb of a slider or a scrollbar displayed on the display window of a screen, the method comprising:
generating an identifier representing selected data if one of the search data is selected;
displaying the identifier on the display window;
maintaining the identifier on the display window for a certain time even when another search data is being displayed according to the movement of the thumb; and
displaying data corresponding to selected identifier on the display window if the maintained identifier is selected.

10. The method of claim 9, wherein the maintaining of the identifier comprises removing the identifier from the display window after the certain time.

11. The method of claim 9, wherein the maintaining of the identifier comprises moving the identifier around the display window for the certain time.

12. The method of claim 11, wherein the maintaining of the identifier further comprises removing the identifier from the display window if a movement time of the identifier exceeds the certain time, or if the identifier is moved to a predetermined position for the certain time.

13. An apparatus for displaying search data, comprising:
a display unit displaying data; and
a control unit generating an identifier representing selected data to display the identifier on a screen of the display unit if one of data displayed on the display unit is selected, maintaining the identifier on the screen even when another data is being displayed, and displaying the data corresponding to the identifier on the screen if the identifier maintained on the screen is selected.

14. The apparatus of claim 13, wherein, when the data is displayed on a specific display window of the screen, the control unit displays the identifier on the specific display window and maintains the identifier on the specific window even when the other data is being displayed.

15. The apparatus of claim 13, wherein the control unit maintains the identifier on the screen for a certain time.

16. The apparatus of claim 15, wherein the control unit removes the identifier from the screen after the certain time.

17. The apparatus of claim 13, wherein the control unit moves the identifier around the screen.

18. The apparatus of claim 17, wherein the control unit removes the identifier from the screen if a predetermined time is up, or if the identifier is moved to a predetermined position, the control unit calculating an initial position or time when the identifier is displayed for the first time, and removing the identifier on the basis of the initial position and the predetermined position or the initial time and the predetermined time.
